(19) United States
(12) Patent Application Publication
(10) Pub. No.: US 2010/0021231 A1
(43) Pub. Date: Jan. 28, 2010

(54) ARRANGEMENT HAVING A HOLLOW PANEL AND A JOINT FITTING

(76) Inventors: Rolf Herbstreit, Waldachtal (DE); Martin Linka, Horb (DE); Frank Burkhardt, Freudenstadt (DE); Peter Schillinger, Ebhausen (DE); Wolfgang Nehl, Waldachtal (DE)

Correspondence Address: MICHAEL J. STRIKER, 103 EAST NECK ROAD, HUNTINGTON, NY, 11743, US

(21) Appl. No.: 12/439,965

(22) PCT Filed: Sep. 11, 2007
(86) PCT No.: PCT/EP07/07887

§ 371 Date: Mar. 4, 2009

(30) Foreign Application Priority Data
Oct. 20, 2006 (DE) 10 2006 049 611.6

(51) Int. Cl. F16B 1/00

(52) U.S. Cl. 403/408.1

(57) ABSTRACT

The invention relates to an arrangement (11) having a hollow panel (1), for example a honeycomb panel, and a joint fitting (6). For the purpose of stable fixing, the invention proposes that the joint fitting (6) be inserted through a hole in a covering panel (3) of the hollow panel (1) and into a counterbore on the inside of the other covering panel (4) of the hollow panel (1). As a result, the joint fitting (6) is provided with stable support against forces in a radial direction, that is to say against forces acting in the plane of the panel. There can be inserted into the joint fitting (6), for example, an eccentric clamp (19) known per se, by means of which, as a result of rotation, a tension anchor (14) can be tensioned.

The invention relates to an arrangement having a hollow panel and a joint fitting, in accordance with the preamble of claim 1. A “joint fitting” means, especially, one part of a multi-part joint fitting.

The invention is directed to provision of a joint or a possible way of joining to a hollow panel. Such hollow panels are used in the furniture industry. They have two covering panels spaced apart from one another and parallel to one another, which are connected to one another, for example, by means of a honeycomb structure. In the latter case they are also referred to as honeycomb panels. A joint fitting for joining the hollow panel to another component has to be fixed to one of the two covering panels of the hollow panel, because the intermediate space between the two covering panels does not provide a possibility for sufficiently stable anchoring. The fixing of a joint fitting is problematic when the hollow panel is to be “butt-jointed” to the other component, that is to say joined with one of its edges butting against the other component, because in this case the hollow panel has to take up tensile forces acting in its intermediate space in a plane of the panel.

For solid panels, that is to say, for example, panels made of a single piece of wood or glued-together wooden panels, eccentric clamps are known for butt-jointing the panel. The eccentric clamps have a cylindrical shape. They are hollow and have a slot, which extends in a circumferential direction and which becomes increasingly deep in a circumferential direction in a spiral shape. As a result of rotation of the eccentric clamp, the head of a tension anchor that extends through the slot is drawn deeper inside the eccentric clamp, as a result of which the panel can be butt-clamped against another component. The eccentric clamp is inserted into a cylindrical blind hole in the solid panel. Such eccentric clamps are unsuitable for a hollow panel, because they do not find sufficient hold in the intermediate space between the covering panels.

In order to fix an eccentric clamp of such a kind in a hollow panel so that the clamp is rotatable, the Utility Model DE 20 2005 007 822 U1 provides a two-part fitting having a kind of bushing and a counterpart piece which is capable of latching into place stepwise in an axial direction and has a foot in the shape of a countersunk screw head. The known fitting is inserted into a hollow panel through a hole in one of the two covering panels so that the foot comes up against the inside of the other covering panel. The foot is adhesively bonded to the covering panel. Consequently, the known fitting has hold in the radial direction in the hole in the one covering panel and as a result of the adhesive bonding with the other covering panel. The known eccentric clamp is inserted in the bushing-like part of the known fitting and can then be used in the usual manner.

The Offenlegungsschrift DE 10 2005 060 528 A1 discloses a solution which to that extent is similar, which proposes that a sleeve-shaped insert be inserted into a hollow panel through a hole in one of the two covering panels and be joined to the inside of the other covering panel by means of a material-based connection, for example by melting a thermoplastic material using ultrasound. In this case too, as in the above-discussed Utility Model, the insert has hold on both covering panels and can consequently be loaded in a radial direction, that is to say in the intermediate space between the covering panels of the hollow panel and in the plane of the panel.

The problem of the invention is to propose an arrangement having a hollow panel and a joint fitting which can be fixed in the hollow panel without a material-based connection and which has good hold against forces acting in the intermediate space of the hollow panel in the plane of the panel.

The problem is solved in accordance with the invention by the features of claim 1. The joint fitting of the arrangement according to the invention is arranged in a hole in one of the two covering panels of the hollow panel and, on the inside of the other covering panel, it is in engagement with the other covering panel of the hollow panel in a shape-based connection. The shape-based connection can be accomplished, for example, by one or more spikes or by one or more sharp edges intersecting, for example in a waffle-like pattern, on an end face of the joint fitting, which impress themselves into the inside of the other covering panel of the hollow panel. Adhesive bonding or other material-based connection of the joint fitting with one or both of the covering panels of the hollow panel is not necessary but the invention does not rule out that possibility. In the plane of the panel, the joint fitting is supported by both covering panels of the hollow panel in a shape-based connection and, as a result, is stably held in the hollow panel. As a result, it can take up the forces necessary for butt-jointing of the hollow panel. On disconnection, for example in order to disassemble a piece of furniture, the joint fitting can remain in the hollow panel and can be re-used without impairing its hold in the hollow panel. This also holds true for disconnecting and re-connecting the hollow panel a number of times. The joint fitting can be used for screwing in a screw, it can take the form of an eccentric clamp of the kind mentioned at the beginning or it can have a cylindrical cavity for accommodating such an eccentric clamp in rotatable manner. Fixing of the joint fitting in the arrangement according to the invention in the hollow panel is quick and simple and can be accomplished using hand tools available in furniture construction; the joint fitting can be fully loaded immediately after insertion in the hollow panel.

In a preferred embodiment of the invention, the joint fitting engages in a counterbore on the inside of the other covering panel. The counterbore can be made on drilling the hole in the first covering panel.

The arrangement is preferably so produced that it is not visible on the outside of the other covering panel. This means that the outside of the other covering panel is not altered as a result of mounting the joint fitting in the hollow panel; the outside of the other covering panel can, as a result, be used as the fair-faced side of the hollow panel.

For matching to varying thicknesses of different hollow panels there is provided, in an embodiment of the invention, a telescopic joint fitting, which means that its length or, in more general terms, its dimension in the thickness direction of the hollow panel is variable.

In an embodiment of the invention, the joint fitting is provided in the form of a countboring drill bit, by means of which the counterbore can be produced on the inside of the other covering panel, in which the joint fitting engages. As a result, a tool specifically for the purpose of producing the counterbore is not required. Preference is given to also using the joint fitting in the form of a counterboring drill bit for drilling the hole through the first covering panel of the hollow panel. Drilling the hole through the first covering panel, producing the counterbore on the inside of the other covering panel and also, at the same time, arranging the joint fitting in the hollow panel are accomplished without a separate tool and in a single operation.

In an embodiment of the invention there is provided at least one rearwardly-engaging element, which engages the rear of the first covering panel of the hollow panel on the inside thereof, which covering panel is provided with the hole. The rearwardly-engaging element provides support for the joint element in an axial direction against the first covering panel and improves the hold of the joint fitting on the first covering panel. Preferably, a plurality of rearwardly-engaging elements are provided distributed around the circumference or one rearwardly-engaging element extends over a region of the circumference of the joint fitting. The rearwardly-engaging element can be in the form of a snap-in or latch-in projection; it can be maintained in an outwardly projecting position by an eccentric clamp inserted in the joint fitting so that it cannot be pushed in and the joint fitting cannot be removed from the hollow panel when the eccentric clamp is in the inserted state in the joint fitting.

The invention will be explained in greater detail hereinbelow with reference to examples of embodiments shown in the drawings. The three Figures show sectional views of three examples of embodiments of arrangements according to the invention.

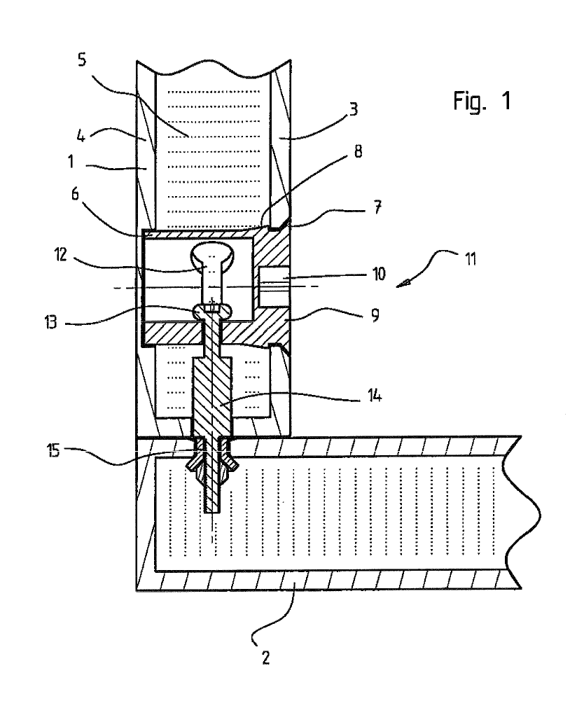

In FIG. 1, a hollow panel 1 is joined to a further panel 2. The hollow panel 1 is a honeycomb panel having two covering panels 3, 4, which are arranged spaced apart from one another and parallel to one another and which are joined to one another by a honeycomb structure 5. The other panel 2 is also a honeycomb panel but this is not of importance here. The hollow panel 1 is butt-jointed to the other panel 2, that is to say one of its edges “butts” against the other panel 2. A joint fitting 6 is inserted in the hollow panel 1. The joint fitting 6 is tubular; it has a countersunk-head-like flange 7 at one end face. At a spacing from that end, corresponding to the thickness of the first covering panel 3, the joint fitting 6 has resilient latching projections 8. The latching projections 8 are barb-like; they are arranged distributed uniformly or, alternatively, non-uniformly around the circumference of the tubular joint fitting 6, project outwards in a lateral direction and can with resilience be introduced in an inward direction into recesses in the joint fitting 6. That end of the joint fitting 6 which is provided with the flange 7 is closed off by means of an end wall 9, which has a cross slot 10 or some other tool receiver such as, for example, a transverse slot or a hexagon socket (not shown) for application of a rotating tool (not shown). The other end of the joint fitting 6 is open.

In order to insert the joint fitting 6, a hole is drilled through the first covering panel 3 of the hollow panel 1. The other covering panel 4 is provided with a cylindrical counterbore on its inside. The joint fitting 6 is inserted in the hole in the first covering panel 3; the countersunk-head-like flange 7 is recessed flush in the covering panel 3. The latching projections 8 are resiliently extended outwards on the inside of the covering panel 3 and engage the rear of the covering panel 3 on the inside. As a result, the joint fitting 6 is axially fixed but rotatable in the covering panel 3. The other end of the joint fitting 6 engages in the counterbore on the inside of the other covering panel 4 of the hollow panel 1. The joint fitting 6 is, as a result, held at its two ends in a shape-based connection in the covering panels 3, 4 of the hollow panel 1 against loading in a radial direction. As a result it can take up strong forces acting in the intermediate space between the two covering panels 3, 4 of the hollow panel 1 in the plane of the panel. The hollow panel 1 together with the joint fitting 6 inserted therein and supported radially in both covering panels 3, 4 by means of a shape-based connection forms an arrangement 11 according to the invention. The latching projections 8 form rearwardly-engaging elements, which engage the rear of the first covering panel 3 of the hollow panel 1 on the inside thereof. The counterbore on the inside of the other covering panel 4 of the hollow panel 1 need not necessarily be cylindrical; it can, for example, also be conical (not shown) corresponding to the tip of a drill bit used for drilling the hole through the covering panel 3.

The joint fitting 6 is in the form of an eccentric clamp. It has an introduction hole 12 in its circumferential wall for introducing the head 13 of a tension anchor 14 in a radial direction into the interior of the tubular joint fitting 6. From the introduction hole 12 a slot extends over about 180° in the circumferential direction of the joint fitting 6. The wall thickness of the joint fitting 6 increases, starting from the introduction hole 12, in the direction in which the slot extends, that is to say the slot becomes deeper in the circumferential direction. As a result of rotating the joint fitting 6 through about 180°, the tension anchor 14 is drawn, by its head 13, deeper into the joint fitting 6, which is in the form of an eccentric clamp, and as a result clamps the edge of the hollow panel 1 against the other panel 2. Such eccentric clamps are known per se and will not therefore be explained in further detail here. The tension anchor 14 is anchored in the other panel 2, for example by means of a fixing plug 15.

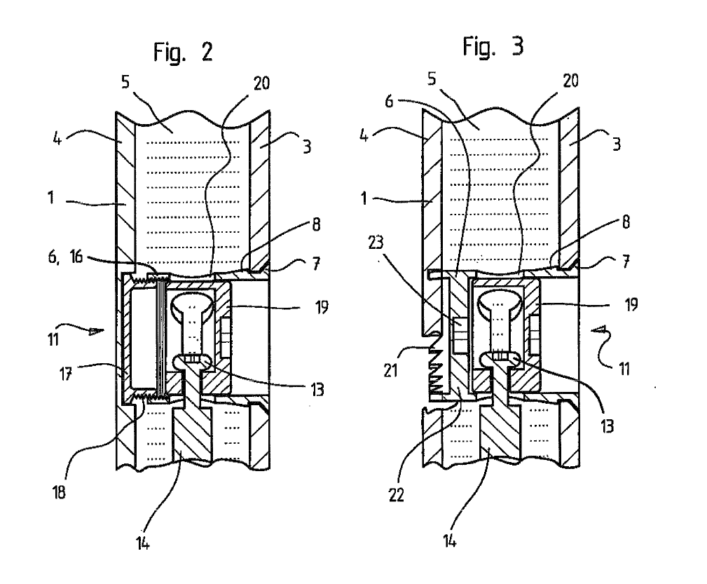

In FIGS. 2 and 3, components that correspond to FIG. 1 are referred to by the same reference numerals. In the following explanation of FIGS. 2 and 3, the differences of substance from FIG. 1 are set out and, in addition, reference should be made to the statements regarding FIG. 1.

The joint fitting 6 shown in FIG. 2 is of two parts; its first part 16 corresponds substantially to the joint fitting 6 of FIG. 1. The second part 17 is latched onto the open end of the first part 16 of the joint fitting 6. For the purpose of latching, the second part 17 is provided with a circumferential toothed arrangement 18, which is in engagement with a complementary internally toothed arrangement of the first part 16. The other part 17 is in the shape of a cylinder cap. As a result of the circumferential toothed arrangement, which allows deeper introduction of the other part 17 into the first part 16 of the joint fitting 6 and, therefore, matching of the length of the joint fitting 6 to the thickness of the hollow panel 1, the joint fitting 6 is telescopic.

As in FIG. 1, the first covering panel 3 of the hollow panel 1 in FIG. 2 is provided with a hole and the other covering panel 4 is provided with a cylindrical counterbore on its inside. For the purpose of insertion, the cap-shaped second part 17 of the joint fitting 6 is introduced only a short distance in the other part 16. As in FIG. 1, the joint fitting 6 in FIG. 2 is also pushed through the hole in the first covering panel 3. Once the other part 17 comes up against the bottom of the counterbore in the other covering panel 4 of the hollow panel 1 and the first part 16 is pushed further into the hollow panel 1 until it finishes flush with the first covering panel 3, the toothed arrangement 18 of the other part 17 latches into place further up the end of the first part 16 of the joint fitting 6. As a result, the joint fitting 6 matches itself to the thickness of the hollow panel 1. The countersunk-head-like flange 7 and the latching projections 8 are present on the first part 16 of the joint fitting 6 of FIG. 2 as they are on the joint fitting 6 of FIG. 1. The joint fitting 6, inserted in the hollow panel 1, and the hollow panel 1 form the arrangement 11 according to the invention. In contrast to FIG. 1, that end of the first part 16 of the joint fitting 6 which is provided with the flange 7 is open, and an eccentric clamp 19 known per se is inserted in the joint fitting 6. The eccentric clamp 19 is rotatably accommodated in the joint fitting 6. On its circumference, the tubular first part 16 of the joint fitting 6 has at least one and preferably a plurality of holes 20 arranged distributed over the circumference, through which holes the head 13 of a tension anchor 14 can be introduced into the eccentric clamp 19 so that the tension anchor 14 can, as a result of rotation of the eccentric clamp 19, be tensioned in a manner known per se.

Like the joint fitting 6 of FIG. 1, the joint fitting 6 of FIG. 3 is tubular and of one part. Its end face remote from the flange 7 is provided with sawteeth 21. As a result of the sawteeth 21, the joint fitting 6 is in the form of a counterboring drill bit. As a result of being driven in rotation, the joint fitting 6 itself drills or saws out the hole in the first covering panel 3 of the hollow panel 1 and saws out an annular counterbore for itself on the inside of the other covering panel 4. A separate drilling tool is not required; as a result of the drilling, the joint fitting 6 of FIG. 3 is installed at the same time.

That end of the joint fitting 6 which is provided with the flange 7 is open so that, as in FIG. 2, an eccentric clamp 19 can be inserted in the joint fitting 6. For the purpose of being driven in rotation, the joint fitting 6 has a wall 22 in a radial plane, which is arranged between the eccentric clamp 19 and the sawteeth 21. The wall 22 has a hexagon socket 23 or some other tool receiver for application of a rotary tool for conjoint rotation therewith in a shape-based connection.

1. Arrangement having a hollow panel (1) and a joint fitting (6) which is arranged in a hole in the hollow panel (1), the hollow panel (1) having two covering panels (3, 4), the hole in which the joint fitting (6) is arranged being provided in the first (3) covering panel, characterised in that the joint fitting (6) is in engagement, in a shape-based connection, with the other covering panel (4) of the hollow panel (1) on the inside.

2. Arrangement according to claim 1, characterised in that the other covering panel (4) has, on its inside, a counterbore, in which the joint fitting (6) engages.

3. Arrangement according to claim 1, characterised in that the outside of the other covering panel (4), on the inside of which the joint fitting (6) is in engagement in a shape-based connection, is unaltered.

4. Arrangement according to claim 1, characterised in that the joint fitting (6) is telescopic.

5. Arrangement according to claim 1, characterised in that the joint fitting (6) has a counterboring drill bit (21) for producing the counterbore.

6. Arrangement according to claim 1, characterised in that the joint fitting (6) has at least one rearwardly-engaging element (8), which engages the rear of the first covering panel (3) of the hollow panel (1) on the inside, which covering panel is provided with the hole.
